(19) United States
(12) Patent Application Publication
(10) Pub. No.: US 2005/0021357 A1
(43) Pub. Date: Jan. 27, 2005

(54) System and method for the efficient creation of training data for automatic classification

(75) Inventors: Hinrich H. Schuetze, San Francisco, CA (US); Omer Emre Velipasaoglu, San Francisco, CA (US); Chia-Hao Yu, Davis, CA (US); Stan Stukov, Burlingame, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ENKATA Technologies, San Mateo, CA (US)

(21) Appl. No.: 10/850,574

(22) Filed: May 19, 2004

Related U.S. Application Data
(60) Provisional application No. 60/471,886, filed on May 19, 2003.

(51) Int. Cl. G06F 17/60

(52) U.S. Cl. 705/1; 705/10

(57) ABSTRACT

A system and method for the efficient creation of training data for automatic classification.

### BACKGROUND OF THE INVENTION

The present invention relates generally to supporting business decisions through data analysis by way of automatic classification. More particularly, the invention provides a method and system for the efficient creation of training data for automatic classifiers. Business decisions generally require knowledge about properties of business entities related to the decision. Such properties can be inferred by an automatic classifier that processes data associated with the entity. The business decision can relate to marketing, sales, procurement, operations, or any other business area that generates and captures real data in electronic form. Merely by way of example, the invention is applied to processing data from a call center of a large wireless telecommunication service provider. But it would be recognized that the invention has a much wider range of applicability. For example, the invention can be applied to other operational and non-operational business areas such as manufacturing, financial services, insurance services, high technology, retail, consumer products, and the like.

Common goals of almost every business are to increase profits and improve operations. Profits are generally derived from revenues less costs. Operations include manufacturing, sales, service, and other features of the business. Companies spent considerable time and effort to control costs to improve profits and operations. Many such companies rely upon feedback from a customer or detailed analysis of company finances and/or operations. Most particularly, companies collect all types of information in the form of data. Such information includes customer feedback, financial data, reliability information, product performance data, employee performance data, and customer data.

With the proliferation of computers and databases, companies have seen an explosion in the amount of information or data collected. Using telephone call centers as an example, there are literally over one hundred million customer calls received each day in the United States. Such calls are often categorized and then stored for analysis. Large quantities of data are often collected. Unfortunately, conventional techniques for analyzing such information are often time consuming and not efficient. That is, such techniques are often manual and require much effort.

Accordingly, companies are often unable to identify certain business improvement opportunities. Much of the raw data including voice and free-form text data are in unstructured form thereby rendering the data almost unusable to traditional analytical software tools. Moreover, companies must often manually build and apply relevancy scoring models to identify improvement opportunities and associate raw data with financial models of the business to quantify size of these opportunities. An identification of granular improvement opportunities would often require the identification of complex multi-dimensional patterns in the raw data that is difficult to do manually.

Examples of these techniques include Naive Bayes statistical modeling, support vector machines, and others. These modeling techniques have had some success. Unfortunately, certain limitations still exist. That is, training sets for modeling must often be established to carry out these techniques. Such training sets are often cumbersome and difficult to develop efficiently. Training sets often change from time to time and must be recalculated. These sets are often made using manual human techniques, which are costly and inefficient. Computerized techniques have been ineffective. Although these techniques have had certain success, there are many limitations.

From the above, it is seen that techniques for processing information are highly desired.

### BRIEF DESCRIPTION OF THE DRAWINGS

FIG. 1 shows a simplified active learning dialog box according to an embodiment of the present invention. The data associated with the business object in this case is text. The text is “automatic payment has been cancelled through phonecarrier.com”. The expert next clicks on either the red minus sign or the green plus sign. The corresponding labeling decision is then collected by the system.

FIG. 2 shows the same active learning dialog box with debug mode enabled according to an embodiment of the present invention. In debug mode, the current iteration of active learning is shown to the user. The particular system shown implements active learning by means of a Naive Bayes classifier. The threshold and probability estimate for the current business object are also shown to the user in debug mode.

FIG. 3 shows the active learning dialog box in the next iteration (iteration 1) according to an embodiment of the present invention.

FIG. 4 shows keyword highlighting according to an embodiment of the present invention. The expert has requested that all occurrences of the string “customer” be highlighted.

FIG. 5 shows the training set inspection dialog box according to an embodiment of the present invention. The expert can choose to view all of the training set (all previously labeled objects plus the initial training set); to view all objects that have the classification property and the current model predicts they don't have it (false negatives); to view all objects that have the classification property and the current model predicts that they have it (true positives); to view all objects that do not have the classification property and the model predicts they do not have it (true negatives); and to view all objects that do not have the classification property and the current model predicts that they have it (false positives).

FIG. 6 shows the model inspection panel according to an embodiment of the present invention. The expert can view selected features and their properties; current performance estimates (precision and recall); and create new features that will be included when the classifier model is regenerated.

FIG. 7 shows a different part of the model inspection panel according to an embodiment of the present invention. The expert can view various system parameters that determine tokenization and feature selection.

FIG. 8 is a simplified drawing of a method according to an embodiment of the present invention.

FIGS. 8.1 to 8.11 are more detailed diagrams illustrating the method of FIG. 8.

FIG. 9 is a diagram of experimental data according to an embodiment of the present invention.

### SUMMARY OF INVENTION

According to the present invention, techniques for supporting business decisions through data analysis by way of automatic classification are provided. More particularly, the invention provides a method and system for the efficient creation of training data for automatic classifiers. Business decisions generally require knowledge about properties of business entities related to the decision. Such properties can be inferred by an automatic classifier that processes data associated with the entity. The business decision can relate to marketing, sales, procurement, operations, or any other business area that generates and captures real data in electronic form. Merely by way of example, the invention is applied to processing data from a call center of a large wireless telecommunication service provider. But it would be recognized that the invention has a much wider range of applicability. For example, the invention can be applied to other operational and non-operational business areas such as manufacturing, financial services, insurance services, high technology, retail, consumer products, and the like.

In a specific embodiment, the present invention provides a method for decision making including formation of training data for classification in support of business decisions. The method includes inputting data representing a first set of business entities from a business process. The data are representative of express information from the first set of business entities. The method includes identifying one or more classification properties for a business decision. The one or more classification properties is capable of being inferred from the data representing the first set of business entities. The method includes determining information from one or more of the business entities. The information may be associated with the one or more classification properties. The method includes building a statistical classifier based upon at least the information to determine whether an entity from the set of business entities may have the one or more classification properties. A step of identifying a metric that measures a degree of informativeness associated with information associated with a selected business entity that may have the one or more classification properties is included. The method includes processing one or more of the business entities to calculate a respective metric and associating each of the processed business entities with the respective metric. The method includes selecting one or more business entities with the respective metric and outputting the one or more selected business entities. The method includes presenting the one or more of the selected business entities to a human user and determining by the human user whether the one or more selected business entities have the one or more classification property or does not have the one or more classification properties. The method includes selecting one or more of the selected business entities to indicate whether the one or more classification properties are included or not included and rebuilding the classifier based upon at least the selected business entities.

In a specific embodiment, the present invention provides a method for the efficient creation of training data for automatic classification in support of business decisions. Here, the term “automatic” includes semi-automatic and automatic, but does not include substantially manual processes according to a specific embodiment, although other definitions may also be used. The method inputs data representing a first set of business entities from a business process. The method identifies one or more classification properties for the business decision that entities from the first set may or may not have. The method selects a second set of business entities from the first set where for each entity from the second set it is unknown whether it has or does not have the classification property. The method includes building a classifier that automatically determines whether an entity has the classification property or not and identifying a metric that measures a desirability of presence or absence of the property for a particular entity will be for retraining the classifier to distinguish between entities with and without the property. The method computes the metric for all entities in a set derived from the second set and selects a third set of one or more entities from the second set. The third set comprises those objects with a highest value for the metric. The method also presents the third set to a person with knowledge about which entities have the classification property and collects expert judgments from the person as to whether each of the entities in the third has the classification property or not. The method then rebuilds the classifier based on the expert judgments.

In an alternative specific embodiment, the invention provides a system including one or more memories. The system includes a code directed to inputting a first set of business entities from a business process. A code is directed to identifying a classification property for the business decision that entities from the second set may or may not have. The system has a code directed to selecting a second set of business entities from the first set where for each entity from the second set it is unknown whether it has or does not have the classification property and a code directed to building a classifier that automatically determines whether an entity has the classification property or not. The system also has a code directed to identifying a metric that measures how valuable knowledge of presence or absence of the property for a particular entity will be for retraining the classifier to distinguish between entities with and without the property. Another code is directed to computing the metric for all entities in a set derived from the second set. Yet another code is directed to selecting a third set of one or more entities from the second set. The third set comprises those objects with the highest value for the metric. The system further includes a code directed to presenting the third set to a person with knowledge about which entities have the classification property. A code is directed to collecting expert judgments from the person as to whether each of the entities in the third has the classification property or not. A code is directed to rebuilding the classifier based on the expert judgments. Depending upon the embodiment, other functionalities described herein may also be carried out using computer hardware and codes.

Many benefits are achieved by way of the present invention over conventional techniques. For example, the present technique provides an easy to use process that relies upon conventional technology. Additionally, the method provides a process that is compatible with conventional process technology without substantial modifications to conventional equipment and processes. Preferably, the present invention provides a novel semiautomatic way of creating a training set using automatic and human interaction. Depending upon the embodiment, one or more of these benefits may be achieved. These and other benefits will be described in more throughout the present specification and more particularly below.

Various additional objects, features and advantages of the present invention can be more fully appreciated with reference to the detailed description and accompanying drawings that follow.

### DESCRIPTION OF THE INVENTION

According to the present invention, techniques for supporting business decisions through data analysis by way of automatic classification are provided. More particularly, the invention provides a method and system for the efficient creation of training data for automatic classifiers. Business decisions generally require knowledge about properties of business entities related to the decision. Such properties can be inferred by an automatic classifier that processes data associated with the entity. The business decision can relate to marketing, sales, procurement, operations, or any other business area that generates and captures real data in electronic form. Merely by way of example, the invention is applied to processing data from a call center of a large wireless telecommunication service provider. But it would be recognized that the invention has a much wider range of applicability. For example, the invention can be applied to other operational and non-operational business areas such as manufacturing, financial services, insurance services, high technology, retail, consumer products, and the like.

Statistical classification is useful in analyzing business data and supporting business decisions. Consider the task of analyzing one million records of telephone conversations for cases where the customer inquires about an account balance. It is costly and time-consuming for a person to read all one million records. It is faster and less costly for a statistical classifier to process all one million records (typically in a manner of minutes) and display the count of records that are account balance inquiries.

To build a statistical classifier one needs a training set: a representative set of objects that are labeled as having the property (for example, being an inquiry about an account balance) or not having the property.

The main difficulty in deploying classification technology in a business environment is the cost-effective creation of training sets. This invention is concerned with an efficient system and method for training set creation. The system and method facilitate creating a training set by make optimal and/or more efficient use of of an expert's time in labeling objects.

We call business objects “labeled” if we know whether or not they have the classification property according to a specific embodiment. An object can be labeled because its properties are somehow known beforehand. Or it can be labeled because it was assigned by the expert to the set of objects with the property or to the set of objects without the property. If the business object is not labeled, we call it “unlabeled.” The terms labeled and unlabeled can also have other meanings consistent with the art without departing from the scope of the claims herein. One of ordinary skill in the art would recognize other variations, modifications, and alternatives.

The main idea of active learning is that in each iteration, we select those unlabeled objects who will benefit the classifier most once we know their properties. This makes maximum or more efficient use of the time and effort that the expert has to put into expert judging as each bit of information contributed by the expert has maximum benefit.

One way of assessing the potential benefit of knowing an object's classification property is to build classifiers that compute a probability distribution over objects, and then compute the expected benefit of knowing the object's class membership using this probability distribution. There are many other ways of computing potential benefit.

We can select one object per iteration to be presented to the user or we can present more than one object in each iteration.

Maximum uncertainty can be defined as the probability estimate that is closest to 0.5 for a probabilistic classifier. There are many other ways of defining maximum uncertainty.

One hard problem is how to perform the very first iteration of active learning when the expert has not labeled any objects yet. Possible approaches are to start with a training set that is available from another source; to start with a random classifier; to perform some form of search over all records; to perform some form of clustering and to identify clusters that correspond to objects that do and objects that do not have the classification property; or to use a classifier of a related classification property that was constructed previously.

In many cases, the best or more efficient performance is achieved when the second set of objects is very large. For example, it may comprise hundreds of thousands or even millions of objects. Computing the metric for all objects in the second set can take more than a minute. This means that the expert has to wait a minute for the next set of objects to be judged to come up. This is not a good way of using the expert's time. One way to speed up this process is to deploy a multi-tier architecture. Each tier has a different order of magnitude. For example, 1,000,000,000 objects (low tier), 1,000,000 objects (medium tier), and 1,000 objects (high tier). Each tier has a thread running on it that computes a smaller set with two properties: 1. it has the size of the next highest tier 2. it contains the highest scoring unlabeled objects from this tier. The tiers are updated whenever the corresponding thread is done. This usually will not be synchronous with the active learning iteration that the expert sees. For example, the same set of 1,000,000 may be used for several iterations even though the model will be updated after each iteration, and scores for the set of 1000 may be computed in each active learning iteration and the highest scoring object shown to the expert.

As an example, an important area of business decisions that can be supported with training set creation is customer interaction data as they occur in contact centers or, in general, in businesses with many consumers as customers. In this type of business, there are often multiple touch points: systems that the customer interacts with and that then generate data that capture the interaction. In such an environment, the business objects that are classified might be customer activities (the data associated with a single interaction of a customer with one system); customer interactions (all activities that represent one interaction of the customer with multiple systems); or customer profiles (the information about the customer that the business has captured at a certain time).

An important type of business decision that can be supported by training set creation and classification concerns operational decisions in another alternative.

In the case where data associated with a business object comes from several different sources (e.g., different systems for customer interactions), one often wants to select those sources that contribute information to the classification. Hence, source selection is part of what is claimed in this invention.

For any given source, many different types of information may be associated with a business object. Selecting the relevant types of information can increase efficiency and accuracy of training and classification. Hence, information type selection and feature selection are part of what is claimed in this invention.

In case a feature vector representation is chosen for the data associated with an object, and if part of the data is text, one can use words as features. One can also use letter n-grams as features. There are many other possibilities.

Before presenting methods according to the present invention, we have briefly explained each of the following diagrams that will be useful in describing the present invention. These diagrams are merely examples, which should not unduly limit the scope of the claims herein. One of ordinary skill in the art would recognize many variations, modifications, and alternatives.

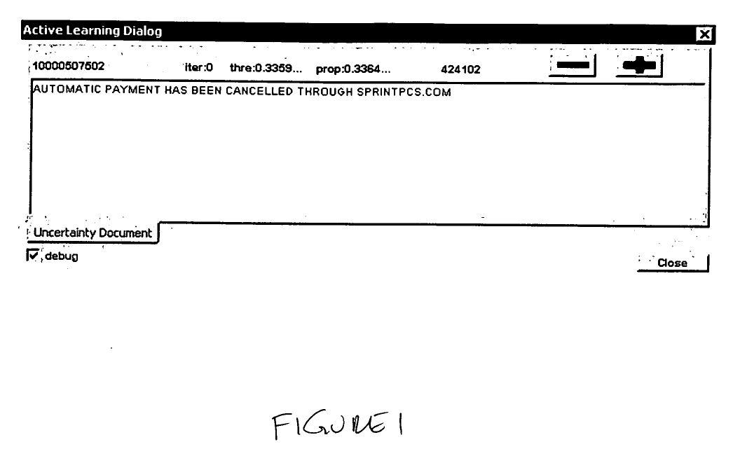

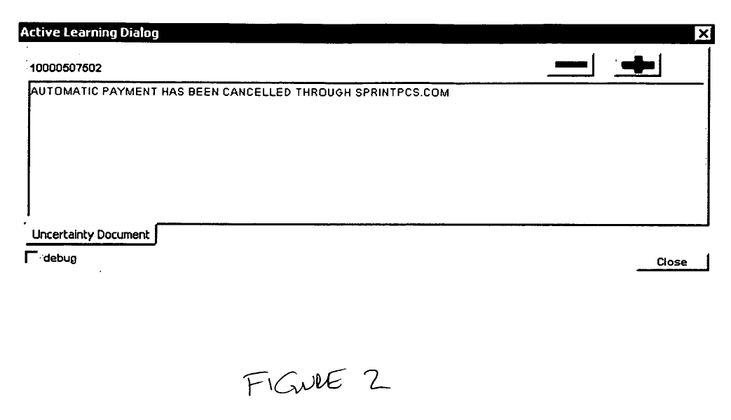

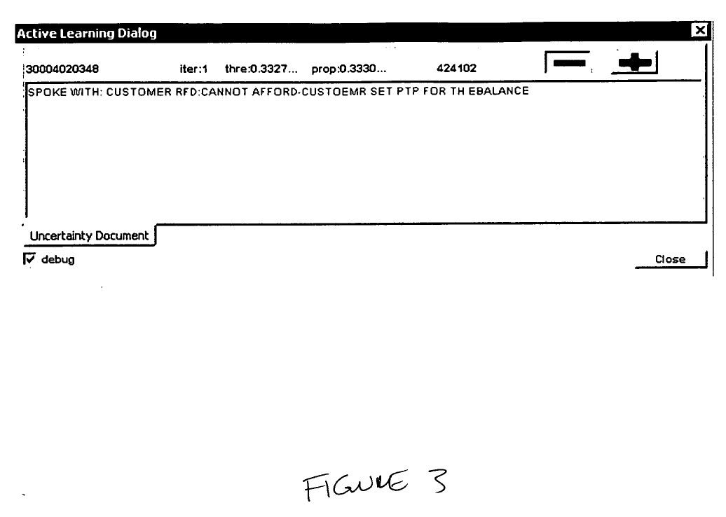

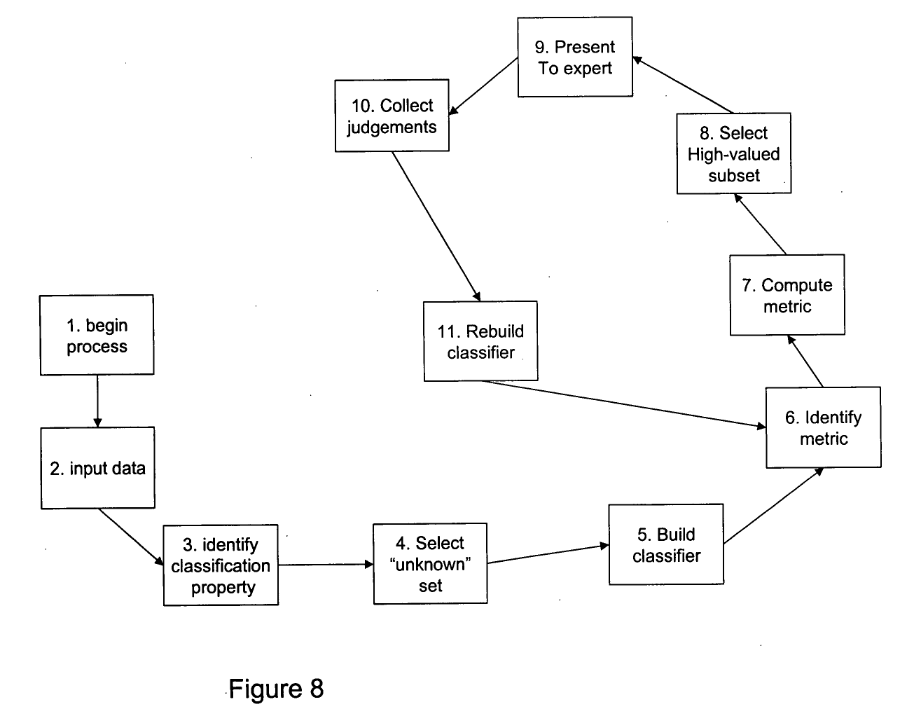

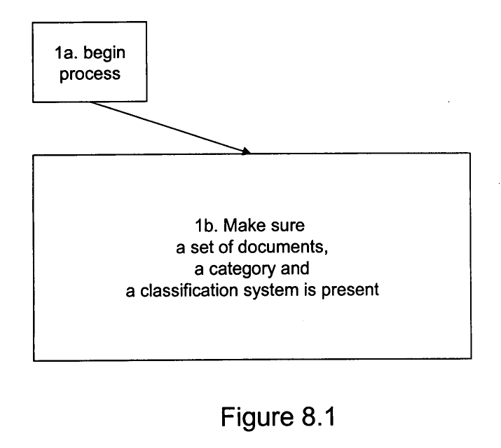

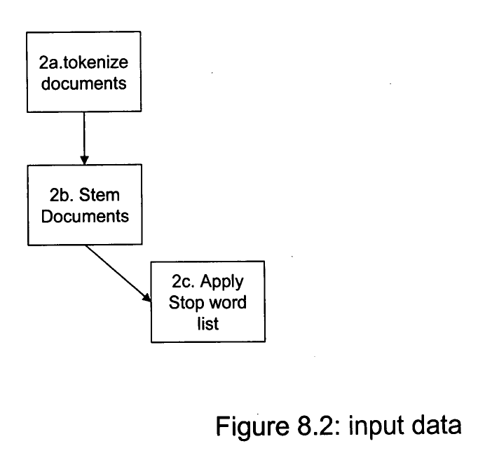

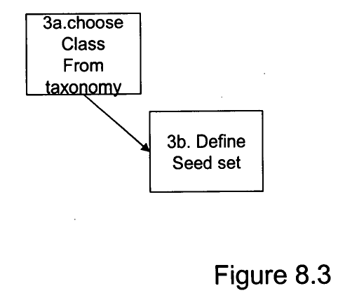

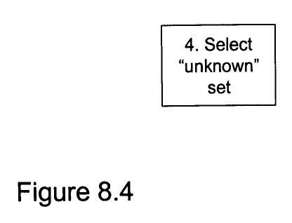

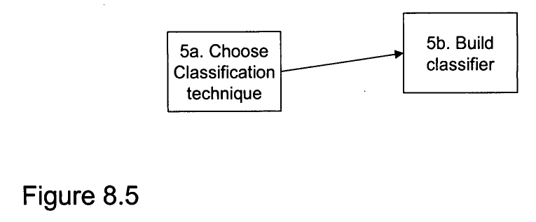

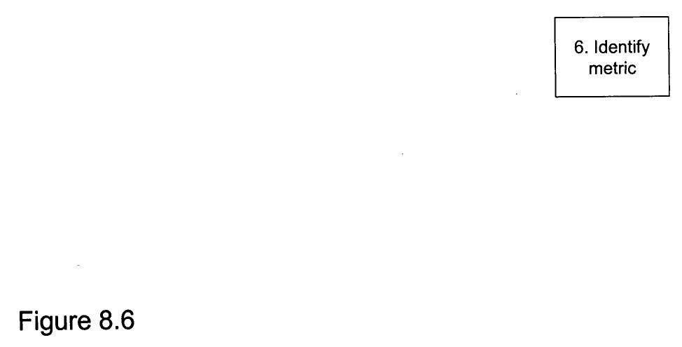

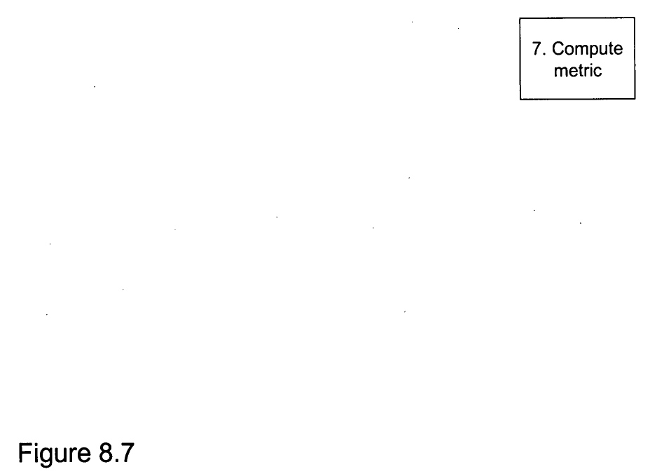

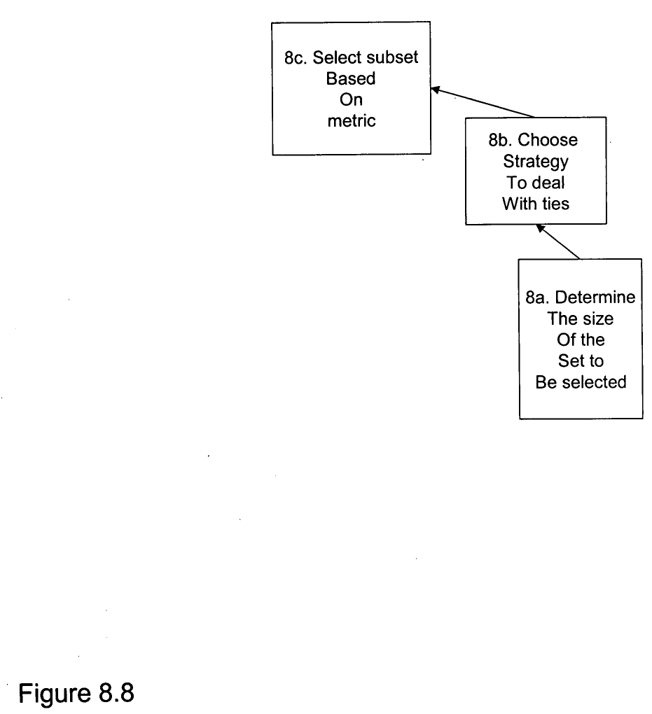

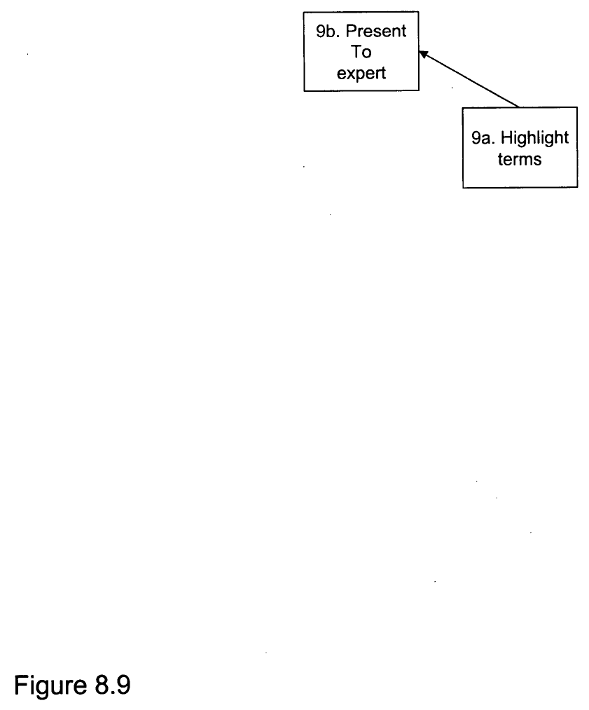

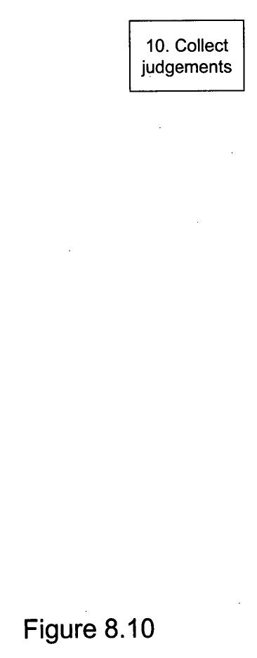

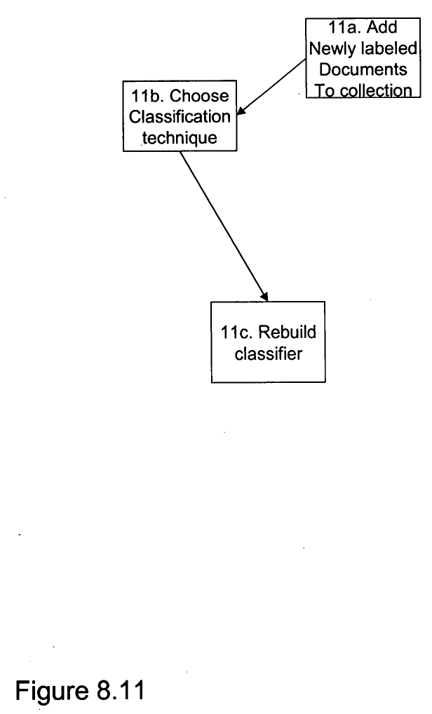

To assist the reader in understanding aspects of the present invention, FIGS. 1-4 are associated with steps 6-11 in FIG. 8. FIG. 8 illustrates an exemplary embodiment of the present invention. Each of FIGS. 1-4 show step 9: data is presented to the human expert for judgment. After the user selects either plus or minus, steps 10, 11, 6, 7, 8, and 9 are triggered: the judgment is collected, the classifier is rebuilt, a metric is identified, the metric is computed, a high-valued subset is selected, and this subset (in this case one text document) is presented to the human expert. Of course, one of ordinary skill in the art would recognize other variations, modifications, and alternatives.

FIG. 1 shows a simplified active learning dialog box according to an embodiment of the present invention. The data associated with the business object in this case is text. The text is “automatic payment has been cancelled through phonecarrier.com”. The expert next clicks on either the red minus sign or the green plus sign. The corresponding labeling decision is then collected by the system.

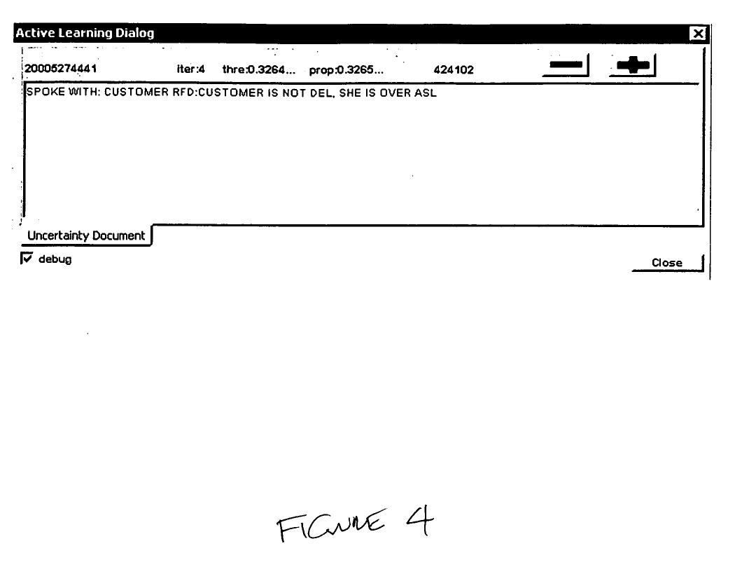

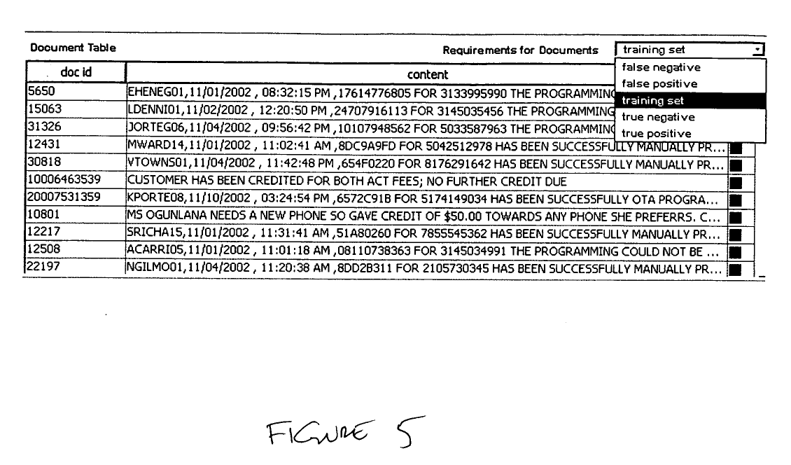

FIG. 2 shows the same active learning dialog box with debug mode enabled according to an embodiment of the present invention. In debug mode, the current iteration of active learning is shown to the user. The particular system shown implements active learning by means of a Naive Bayes classifier. The threshold and probability estimate for the current business object are also shown to the user in debug mode.

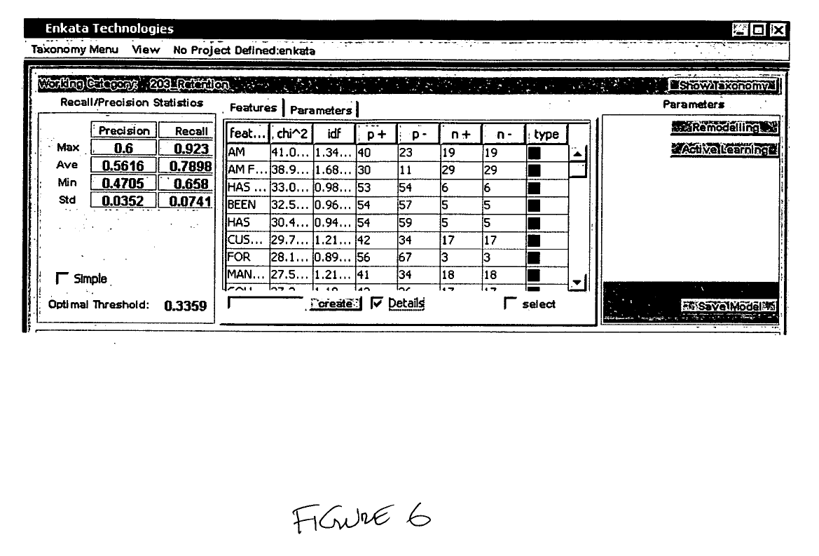

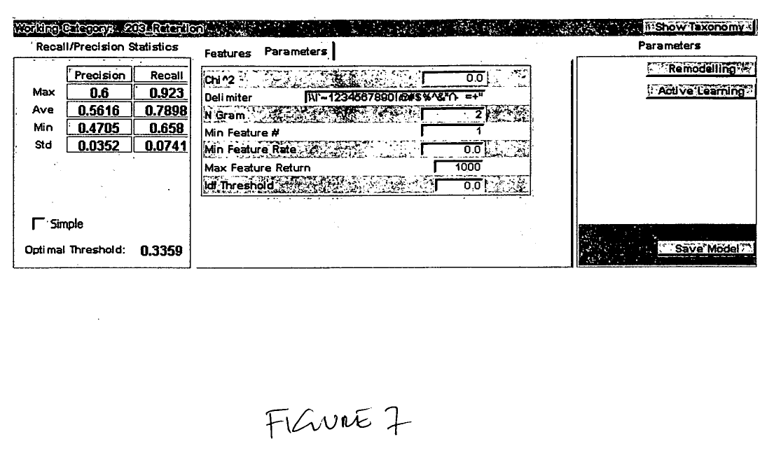

FIG. 3 shows the active learning dialog box in the next iteration (iteration 1) according to an embodiment of the present invention.

FIG. 4 shows keyword highlighting according to an embodiment of the present invention. The expert has requested that all occurrences of the string “customer” be highlighted.

In describing other aspects of the present method and systems, we refer to FIGS. 5 through 7. These diagrams are merely illustrations and are not intended to unduly limit the scope of the claims herein. One of ordinary skill in the art would recognize other variations, modifications, and alternatives.

FIG. 5 shows the training set inspection dialog box according to an embodiment of the present invention. The expert can choose to view all of the training set (all previously labeled objects plus the initial training set); to view all objects that have the classification property and the current model predicts they don't have it (false negatives); to view all objects that have the classification property and the current model predicts that they have it (true positives); to view all objects that do not have the classification property and the model predicts they do not have it (true negatives); and to view all objects that do not have the classification property and the current model predicts that they have it (false positives).

FIG. 6 shows the model inspection panel according to an embodiment of the present invention. The expert can view selected features and their properties; current performance estimates (precision and recall); and create new features that will be included when the classifier model is regenerated.

FIG. 7 shows a different part of the model inspection panel according to an embodiment of the present invention. The expert can view various system parameters that determine tokenization and feature selection.

According to an embodiment of the present invention, a method can be outlined as follows, which can also be referenced by FIG. 8:
1. Begin process;
2. Input data representing a first set of business entities from a business process;
3. Identify a classification property for the business decision that entities from the first set may or may not have;
4. Select a second set of business entities from the first set where for each entity from the second set it is unknown whether it has or does not have the classification property;
5. Build a classifier that automatically determines whether an entity has the classification property or not;
6. Identify a metric that measures how valuable knowledge of presence or absence of the property for a particular entity will be for retraining the classifier to distinguish between entities with and without the property;
7. Compute the metric for all entities in a set derived from the second set;
8. Select a third set of one or more entities from the second set, the third set comprising those objects with the highest value for the metric;
9. Present the third set to a person with knowledge about which entities have the classification property;
10. Collect expert judgments from the person as to whether each of the entities in the third has the classification property or not;
11. Rebuild the classifier based on the expert judgments;
12. Perform other steps, as desired.

The above sequence of steps is merely illustrative. There can be many alternatives, variations, and modifications. Some of the steps can be combined and others separated. Other processes can be inserted or even replace any of the above steps alone or in combination. One of ordinary skill in the art would recognize many other variations, modifications, and alternatives. Further details of the present method can be found throughout the present specification and more particularly below.

Training Set Creation

In a specific embodiment, the present invention provides a method for creating training sets according to the following steps. These steps may include alternative, variations, and modifications. Depending upon the application, the steps may be combined, other steps may be added, the sequence of the steps may be changed, without departing from the scope of the claims herein. Details with regard to steps are provided below.

1. Begin Process

According to a specific embodiment, the process begins by making sure that the requirements or features for running active learning are satisfied. The following should be present: a set of documents, a category defined in a taxonomy or taken from another source, and a system that can process the documents and user input as described in the following steps.

In the example, we processed a data set of 265596 agent notes from a large telecommunications company. The category is “fraud.” The classification system is written in “Python” running on a PC based computer such as those made by Dell Computer of Austin Texas using a Pentium based processor.

2. Input Data

A set of documents is often preprocessed as part of inputting it into the system. Pre-processing steps can include tokenizing, stemming, and others. As an example, tokenization, stemming, and more complex forms of natural language processing are possible techniques that can be applied as part of this process.

In the example, there are initially 15 agent notes that are labeled as belonging to the fraud category and 44 that are labeled as not belonging to fraud. Documents are represented by replacing all special characters with white space and then treating white spaces as word boundaries. All words are treated as potential features after removal of a small number of stop words (such as “the” and “a”).

3. Identify Classification Property

A classification property is equivalent to a class. The user chooses one of the classes from the taxonomy if one exists or from some other source or defines a class from scratch. The user also identifies an initial seed set, a small set of documents labeled as positive or negative with respect to class membership. The seed set needs to contain at least one positive and at least one negative document.

In the example, the classification property is “fraud.” Does this agent note indicate fraud: yes or no? The initial seed set is the set of 15+44 described above.

4. Select Unknown Set

The user chooses a document set to work with. This document set can have an entire set of documents that was input into the system or a subset.

In the example, we choose to work with the entire document set (15+44 labeled, 265596-(15+44) unlabeled).

5. Build Classifier

The system builds a statistical classification model using one of the well-known classification techniques, such as regression, regularized regression, support vector machines, Naive Bayes, k nearest neighbors etc.

In the example, we build a Naive Bayes classifier for the training set consisting of the 15+44 labeled agent notes. The Naive Bayes classifier consists of a weight for each word and a threshold. We classify a document by multiplying each occurring word with its weight and assigning a document to the category if and only if the resulting sum exceeds the threshold.

6. Identify Metric

The metric is used to evaluate the “informativeness” of a document. The term informativeness is a level of desirable or undesirable information that may be included in the document. The objective is to differentiate documents that after labeling do not give the classifier new information from those documents that after labeling and retraining increase the accuracy of the classifier. An example of a metric is the probability of class membership estimated by the current classifier.

In this case, the classifier has to be a probabilistic classifier, or its classification score needs to be transformed into a probability of class membership.

7. Identify Metric

The metric is computed for all documents in the unknown set. If the metric is the probability of class membership, then the classifier is applied to all documents in the unknown set and the probability of class membership is computed for all documents in the unknown set.

In the example, we use as our metric of informativeness the absolute difference of the score of the document from the threshold. The following document had the smallest value for this metric: Based on the information in the 15+44 document training set, there are no terms in this document that indicate clearly that the document is about fraud or that indicate clearly that the document is not about fraud. For that reason it ended up being the most uncertain document, and labeling it and adding it to the training set increases the accuracy of the classifier considerably.

8. Select High-Valued Subset

At this point, the metric is used to select one or more documents with high expected return for future classification accuracy. For the example metric (probability of class membership), closeness to the decision boundary is a good criterion. If it is desired to select a single document, then the one closest to the decision boundary is chosen.

In the example, we select document 17202570.

9. Present to Expert

The selected document is then presented to the user in a way that makes it easy for the user to assess class membership.

For example, certain key words that indicate class membership (or non-membership) may be highlighted. The user is forced to make a yes/no choice. In the example, we present document 17202570 to the human expert. The human expert labels the document as not being about fraud. 10. collect judgments

10. Collect Judgments

The system then collects the judgment. If the user has the option of leaving the document unjudged, the system can present a different document from the selected high-value subset or the system may need to go back to step 8 and select a new high-value subset. The labeled document is then added to the labeled subset. In the example, we add 17202570 to the set of 44 negative documents. We now have 45 negatively labeled documents.

11. Rebuild Classifier

Finally, the classifier is rebuilt using the labeled set augmented by the just labeled subset. Usually, the same classifier is used in each iteration, but different classifiers can be employed in different phases of active learning. For example, in the first phase one may want to employ a classifier that is optimal for small training sets. In later phases, one may want to employ a classifier that is optimal for larger sets.

In the example, we rebuild the classifier, training it now on an expanded training set of 15+45 documents.

While the above is a full description of the specific embodiments, various modifications, alternative constructions and equivalents may be used. Therefore, the above description and illustrations should not be taken as limiting the scope of the present invention which is defined by the appended claims. It is also understood that the examples and embodiments described herein are for illustrative purposes only and that various modifications or changes in light thereof will be suggested to persons skilled in the art and are to be included within the spirit and purview of this application and scope of the appended claims.

Example of Application of Efficient Training Set Creation

For illustrating the effectiveness and efficiency of active learning according to the present invention, we describe here the performance of active learning on one customer-defined classification problem. This example is merely an illustration that should not unduly limit the scope of the claims herein. One of ordinary skill in the art would recognize many variations, alternatives, and modifications. Details of the example are provided below.

The customer is a large telecommunications company. We used a system based upon a Pentium based processor manufactured by Intel Corporation of Santa Clara, Calif. About 120,000 documents from the customer's data set were randomly chosen. The term document consisted of notes made by an agent for a single phone call. We investigated a low frequency category from a plurality of categories. The category under investigation had only 25 positive examples in these 120,000 documents. Such low-frequency categories are difficult if not virtually impossible to learn based on a random subset of the data. An example of such a category was “denied all knowledge of call” when the agent asked the customer of the phone call.

The classifier was designed and tested in a cross-validated setting using active learning according to the present invention. As merely an example, the classifier was similar in design to the one above, but can be others. For each cross-validation fold, the classifier was started from a seed training set of 4 positive and 40 negative examples. At each iteration, the example in the original collection that the current classifier was least certain of was labeled and appended to the training set.

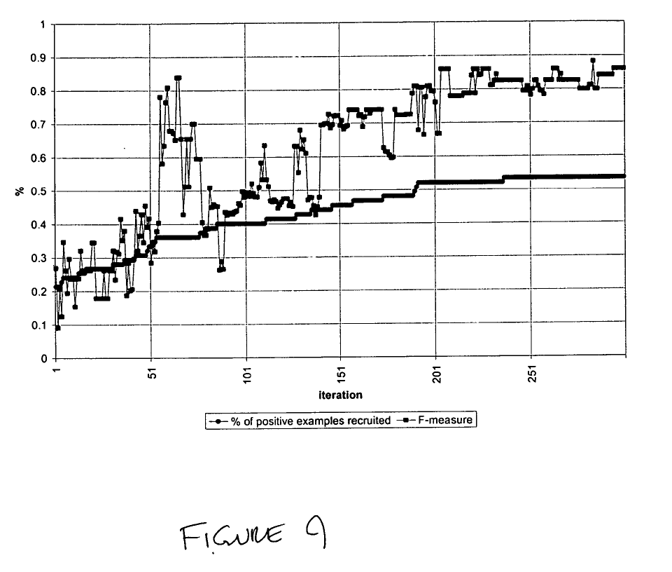

FIG. 9 illustrates a graph produced according to the present example. The graph shows the average F-measure over fourfold cross-validation in red and average rate of recruited positive examples in blue. The F-measure describes the accuracy of the classifier and is defined as the harmonic mean of precision and recall. Precision is the proportion of yes-decisions that are correct and recall is the proportion of documents in the category that were correctly recognized by the classifier.

As illustrated in the graph above, the average F-measure stabilizes around 80% after 200 judged documents (200 iterations with one document each). This corresponds to a total of 244 judgments by the expert (44 in the seed set and 200 iterations at 1 label each). At 200 judgments more than 50% of the available positive examples were recruited, which corresponds to roughly 9 positive examples. (This number can be verified as follows: a quarter of the 25 available examples are held-out for cross-validation. Half of the remaining 18 examples are recruited by the 200th judgment.) Since the seed training set already contains 4 positive examples, the true number of positive examples recruited by active learning is 5. This may seem to be a small number, but the alternative random sampling requires labeling 30,000 of 120,000 examples to be able to find 5 out of 25 positive examples, or over 43,000 examples to find 9. In contrast, active learning required labeling only about 250 examples to achieve the same performance.

An alternative way of looking at performance of active learning is to consider the expected F-measure accuracy had we obtained the training set by random sampling. For example, for 1000 randomly selected examples the performance of the model would be below 20% since the expected number of positive examples is less than 3. This is already 4 times the cost of the current model with classification accuracy nowhere near acceptable. This example demonstrates that the cost of training set creation is reduced dramatically in commercial deployments of statistical classification.

The above methods can be implemented using computer code and hardware. For example, we have implemented the functionality described using object oriented programming languages on an IBM compatible machine.

While the above is a full description of the specific embodiments, various modifications, alternative constructions and equivalents may be used. Therefore, the above description and illustrations should not be taken as limiting the scope of the present invention which is defined by the appended claims. It is also understood that the examples and embodiments described herein are for illustrative purposes only and that various modifications or changes in light thereof will be suggested to persons skilled in the art and are to be included within the spirit and purview of this application and scope of the appended claims.

1. A method for the efficient creation of training data for automatic classification in support of business decisions, the method comprising:
inputting data representing a first set of business entities from a business process;
identifying one or more classification properties for the business decision that entities from the first set may or may not have;
selecting a second set of business entities from the first set where for each entity from the second set it is unknown whether it has or does not have the classification property;
building a classifier that automatically determines whether an entity has the classification property or not;
identifying a metric that measures a desirability of presence or absence of the property for a particular entity will be for retraining the classifier to distinguish between entities with and without the property;
computing the metric for all entities in a set derived from the second set;
selecting a third set of one or more entities from the second set, the third set comprising those objects with a highest value for the metric;
presenting the third set to a person with knowledge about which entities have the classification property;
collecting expert judgments from the person as to whether each of the entities in the third has the classification property or not;
rebuilding the classifier based on the expert judgments.

2. The method of claim 1 wherein the steps of computing the metric, selecting a third set of objects with the highest value, presenting the third set to the person, collecting expert judgments, and rebuilding the classifier is iterated one or more times.

3. The method of claim 2 wherein the metric is maximum uncertainty.

4. The method of claim 2 wherein the metric is highest predicted probability of having the classification property.

5. The method of claim 1 wherein the steps of identifying a metric, computing the metric, selecting a third set of objects with the highest value, presenting the third set to the person, collecting expert judgments, and rebuilding the classifier is iterated one or more times.

6. The method of claim 5 wherein the metric is highest predicted probability of having the classification property for one or more iterations and maximum uncertainty for subsequent iterations.

7. The method of claim 1 wherein the classifier is trained on and applied to a representation of each object, the representation being built from textual data associated with the object, or numeric data associated with the object, or voice recording data associated with the object, or image data associated with the object or a combination of textual, numeric, voice or image data associated with the object.

8. The method of claim 1 wherein the initial classifier is chosen from a set of existing classifiers that perform classification tasks known to be related to the classification property.

9. The method of claim 1 wherein the initial classifier is trained on a training set of objects known to have or not to have the classification property.

10. The method of claim 9 wherein the initial training set is created by way of search over a subset of the first set.

11. The method of claim 9 wherein the initial training set is created by way of clustering.

12. The method of claim 1 wherein the initial classifier is assigning objects randomly.

13. The method of claim 1 wherein the metric is computed for a set derived from the second set that is identical with the second set.

14. The methods of claims 2 wherein a working set is selected from the second set, periodically, but not necessarily in every iteration, the working set comprising all objects with the highest value of the metric.

15. The method of claim 14 wherein the set derived from the second set that the metric is computed over is the working set.

16. The method of claim 1 wherein the objects are customer interactions associated with data from multiple customer touch points.

17. The method of claim 1 wherein the objects are customer activities.

18. The method of claim 1 wherein the objects are customer profiles.

19. The method of claim 1 wherein the classification property is related to an operational improvement opportunity.

20. The method of claim 7 wherein the classification procedure identifies data sources associated with business objects that do not contribute information as to whether an object has the classification property or not.

21. The method of claim 1 wherein objects are represented as vectors in a high-dimensional feature space.

22. The method of claim 21 wherein one or more dimensions of the feature space correspond to words.

23. The method of claim 21 wherein one or more dimensions of the feature space correspond to letter n-grams.

24. The method of claim 21 wherein the classifier is trained by computing a score for each feature indicating the strength of evidence for the classification property provided by this feature.

25. The method of claim 24 wherein the classification decision is made based on the feature scores.

26. The method of claim 24 wherein the classification decision is made based on a linear combination of the feature scores.

27. The method of claim 21 wherein the feature scores are used to divide the set of features into two subsets, the first subset comprising features that contribute to the classification decision and the second subset comprising features that do not contribute to the classification decision, and wherein the first set is retained and the second set is removed.

28. The method of claim 27 wherein one or more features are character sequences and delimiters or tokenization rules are selected by selecting a subset of features compatible with a specific set of delimiters or a specific set of tokenization rules.

29. The methods of claims 2 wherein one or more iterations are pre-computed by creating all possible histories over the one or more iterations, applying each history to the current training set, and training the classifier on the resulting training set.

30. The method of claim 1 wherein for each object, a summary of information associated with the object is displayed to the expert to support the decision as to whether the object has the classification property or not.

31. The methods of claim 2 wherein an estimate of the current performance of the classifier is displayed to the expert to support the decision as to whether to end iterating or not.

32. The method of claim 1 wherein objects in the training set that the classifier deems incorrectly judged by the expert are identified and displayed to the expert for potential change of expert judgment.

33. The method of claim 1 wherein the expert can specify a set of keywords that are to be highlighted if they occur in the data associated with an object that is displayed.

34. A system including one or more memories, the one or more memories comprising:
a code directed to inputting a first set of business entities from a business process;
a code directed to identifying a classification property for the business decision that entities from the second set may or may not have;
a code directed to selecting a second set of business entities from the first set where for each entity from the second set it is unknown whether it has or does not have the classification property;
a code directed to building a classifier that automatically determines whether an entity has the classification property or not;
a code directed to identifying a metric that measures how valuable knowledge of presence or absence of the property for a particular entity will be for retraining the classifier to distinguish between entities with and without the property;
a code directed to computing the metric for all entities in a set derived from the second set;
a code directed to selecting a third set of one or more entities from the second set, the third set comprising those objects with the highest value for the metric;
a code directed to presenting the third set to a person with knowledge about which entities have the classification property;
a code directed to collecting expert judgments from the person as to whether each of the entities in the third has the classification property or not;
a code directed to rebuilding the classifier based on the expert judgments.

35. The method of claim 10 wherein the business objects are associated with text and keyword search is used to identify objects for an initial training set.

36. The method of claim 1 wherein the metric is a combination of maximum uncertainty, maximum probability that an object has the classification property, maximum probability that an object does not have the classification property and wherein a set of objects is selected that has a high score on at least one of these metrics.

37. The methods of claim 2 wherein there are several levels of working sets, the highest level being used for computing a new set of objects to be presented to the user next, the lowest level being identical to the second set, and each level except for the highest level, being subjected to score computation and selection of the highest scoring objects, each level being refreshed from the level below it asynchronously as computation based on a new model becomes available.

38. The methods of claim 2 wherein the metric is computed on a parallel architecture to speed up the computation.

39. The method of claim 7 wherein image data are associated with the object, the representation is derived by segmenting the image into one or more regions, and the representation is derived from the one or more regions.

40. The method of claim 39 wherein the segmentation of images into regions is determined using expert judgments.

41. The method of claim 7 wherein recorded voice data are associated with the object, the representation is derived by segmenting the audio stream into one or more segments, and the representation is derived from the one or more segments.

42. The method of claim 41 wherein the segmentation of recorded voice data into segments is determined using expert judgments.

43. A method for decision making including formation of training data for classification in support of business decisions, the method comprising:
inputting data representing a first set of business entities from a business process, the data being representative of express information from the first set of business entities;
identifying one or more classification properties for a business decision, the one or more classification properties capable of being inferred from the data representing the first set of business entities;
determining information from one or more of the business entities, the information may be associated with the one or more classification properties;
building a statistical classifier based upon at least the information to determine whether an entity from the set of business entities may have the one or more classification properties;
identifying a metric that measures a degree of informativeness associated with information associated with a selected business entity that may have the one or more classification properties;
processing one or more of the business entities to calculate a respective metric;
associating each of the processed business entities with the respective metric;
selecting one or more business entities with the respective metric;
outputting the one or more selected business entities;
presenting the one or more of the selected business entities to a human user;
determining by the human user whether the one or more selected business entities have the one or more classification property or does not have the one or more classification properties;
selecting one or more of the selected business entities to indicate whether the one or more classification properties are included or not included;
rebuilding the classifier based upon at least the selected business entities.

44. The method of claim 43 wherein the selecting the selected business entities selects a highest value of the metric.

45. The method of claim 43 wherein the data comprises a plurality of documents.

46. The method of claim 43 wherein the one or more classification properties is not express information in the data.

47. The method of claim 43 wherein the information comprises a plurality of features.

48. The method of claim 43 wherein the statistical classifier uses the information that may or may not have the one or more properties.

49. The method of claim 43 wherein the degree of informativeness is a value ranging from 50% and less.

50. The method of claim 49 wherein the metric is distance from fifty percent.

51. The method of claim 43 wherein the associating tags each of the processed business entities with the respective metric.

52. The method of claim 43 wherein the selected business entities is a second set of business entities, the second set of business entities is a subset of all of the business entities.

53. The method of claim 43 wherein the presenting is outputted on a display of a computer.

54. The method of claim 43 wherein the human user is a person with expertise in the business process.

55. The method of claim 43 wherein the selecting of the one or more business entities is performed by the human user.

56. The method of claim 43 wherein the rebuilding uses the selected business entities from the human user.
